(19) United States
(12) Patent Application Publication
(10) Pub. No.: US 2026/0254220 A1
(43) Pub. Date: Aug. 27, 2026

(54) ELECTRICAL COUPLING APPARATUS FOR A TRANSMISSION AND DISTRIBUTION ELECTRICAL CONDUCTORS AND METHODS OF ASSEMBLY THEREOF WITH ELECTRICAL CONDUCTORS

(71) Applicant: Classic Connectors, Inc., Trussville, AL (US)

(72) Inventors: Carl Russel Tamm, Trussville, AL (US); Jonathan Prinsloo, Odenville, AL (US); Randy L. Wolf, Trussville, AL (US); Michael Benedict, Trussville, AL (US); Seydou Diop, Birmingham, AL (US); Trisha Crawford, Pell City, AL (US)

(21) Appl. No.: 19/434,494

(22) Filed: Dec. 29, 2025

Related U.S. Application Data
(60) Provisional application No. 63/739,076, filed on Dec. 26, 2024.

(51) Int. Cl. H02G 7/05; H01R 11/14; H02G 1/04; H02G 1/14

(52) U.S. Cl. CPC H02G 7/056; H01R 11/14; H02G 1/04; H02G 1/14

(57) ABSTRACT

An electrical coupling apparatus comprising a housing assembly, an actuating assembly, a core clamping assembly, and a jaw clamp assembly. The actuating assembly includes a tube member and a toggle assembly. The core clamping assembly includes a core slot and a plurality of fingers, with the core clamping assembly movable by the toggle assembly. The jaw clamp assembly includes at least one set of jaws including a plurality of base members and a plurality of corresponding inner jaw members in the tube member. The plurality of fingers is adapted to axially inwardly direct the inner jaw members through movement of the toggle assembly toward the second orientation, to, in turn, allow the inner jaw members to engage and retain the core of the electrical conductor thereby.

### CROSS-REFERENCE TO RELATED APPLICATION

This application claims priority from U.S. patent application Ser. No. 63/739,076 filed Dec. 26, 2024, entitled “Electrical Coupling Apparatus For A Transmission And Distribution Electrical Conductors And Methods Of Assembly Thereof With Electrical Conductors”, the entire disclosure of which is hereby incorporated by reference in its entirety.

### BACKGROUND OF THE DISCLOSURE

### 1. Field of the Disclosure

The disclosure relates in general to transmission and distribution of electricity, and more particularly, to an electrical coupling apparatus for a transmission and/or distribution electrical conductor as well as methods of assembly thereof with electrical conductors. While the electrical coupling apparatus is shown in a configuration as being what is known as a dead end and splice, while not being limited thereto.

### 2. Background Art

Electrical transmission and distribution lines of electrical conductors are well known in the art and include commonly known overhead types. Typically, such electrical conductors may carry voltages of, for example, up to 765,000 Volts, without limitation. Typically, such electrical conductors comprise strands (typically of steel, although may be of a composite, for example) that are helically wound, typically, surrounded by one or more layers of cladding (aluminum or aluminum alloy) that are also typically helically wound.

With the ever increasing temperatures at which it would be desirable to operate such electrical conductors, it has become increasingly important to have electrical couplings that can operate at such increasing temperatures without failing. Additionally, in many instances, electrical couplings may be difficult or time consuming to install, which may be fraught with possible errors in assembly, costly and cumbersome. In some instances, for example, cumbersome tooling is required, as are complicated installation methods that renders proper installation difficult to discern.

### SUMMARY OF THE DISCLOSURE

The disclosure is directed to an electrical coupling apparatus comprising a housing assembly, an actuating assembly, a core clamping assembly and a jaw clamp assembly. The housing assembly has a proximal end and a distal end, and defining a housing channel. The actuating assembly includes a tube member and a toggle assembly. The tube member has a first end and a second end. The toggle assembly is positioned within the tube member. The toggle assembly has a first toggle arm and a second toggle arm. The toggle assembly is movable from a first orientation wherein the first toggle arm and the second toggle arm are oblique to each other to a second orientation wherein the first toggle arm and the second toggle arm are closer to being colinear than in the first orientation. The core clamping assembly includes a core slot adapted to receive a core of an electrical conductor and a plurality of fingers extending in a direction opposite the toggle assembly. The core clamping assembly is movable by the toggle assembly between the first and second orientation thereof. The jaw clamp assembly includes at least one set of jaws including a plurality of base members and a plurality of corresponding inner jaw members, positioned within the tube member. The plurality of fingers is adapted to axially inwardly direct the inner jaw members through movement of the toggle assembly toward the second orientation, to, in turn, allow the inner jaw members to engage and retain the core of the electrical conductor thereby.

In some configurations, the toggle assembly further includes a toggle fastener having a first end and a second end. The toggle fastener is threadedly coupled with the housing assembly so that the second end extends into the housing channel and engages the toggle assembly such that threading of the toggle fastener in one direction directs the toggle assembly toward a second orientation.

In some configurations, the toggle assembly further includes a toggle plunger engageable with the second toggle arm on a first side thereof, and engageable with the core clamping assembly at a second side thereof.

In some configurations, the toggle plunger is slidably movable relative to the core clamping assembly.

In some configurations, the apparatus further comprises a spring positioned between the toggle plunger and the core clamping assembly. The spring is adapted to bias the toggle plunger away from the core clamping assembly. In some such configurations, the apparatus further includes a limiting busing between the toggle plunger and the core clamping assembly. In some such configurations, the spring comprises a plurality of Belleville spring washers.

In some configurations, the core clamping assembly further includes a grab ring having at least one gripping barb extending over a portion of the core slot. The grab ring is adapted to engage a portion of the core of the electrical conductor, to, in turn, limit removal thereof from the core slot.

In some configurations, the core clamping assembly includes an end retaining housing with the core slot being defined thereinto, and a pusher member includes a core passage aligned with the core slot, and wherein the fingers extending therefrom, with the grab ring being sandwiched therebetween.

In some configurations, the core clamping assembly further includes an inspection slot extending through the tube member and the housing assembly and being in communication with the core slot.

In some configurations, the apparatus further comprises an initial positioning assembly including a disk taper associated with the first toggle arm. A disk wedge fastener is threaded to the housing assembly and extending through the tube member. The disk wedge fastener has a second end with a toggle surface. The toggle surface engages the disk taper with threading in a first direction directing the toggle surface to move the disk taper toward the jaw clamp assembly.

In some configurations, a heel plug member is threadedly fastened to the tube member at first end thereof with the second end of the disk wedge fastener being sandwiched between the heel plug member and the disk taper.

In some configurations, the jaw clamp assembly further includes at least two sets of base members and inner jaw members, spaced apart between the first and second ends of the tube member, with spacers positioned between the at least one pair of sets.

In some configurations, the at least two sets of base members and inner jaw members comprises three sets, with three spacers being positioned therebetween.

In some configurations, the jaw clamp assembly further includes a socket at the second end of the tube member and including a bore adapted to receive a core of the electrical conductor, and so that the sets of base member and inner jaw members are positioned between the core clamping assembly and the socket.

In some configurations, the jaw clamp assembly further includes a socket at the second end of the tube member and including a bore adapted to receive a core of the electrical conductor, and including a bushing region adapted to receive a bushing positionable about an end of the core of the electrical conductor.

In some configurations, the inner jaw members and the outer jaw members slidably move relative to each other.

In some configurations, the inner jaw members and the outer jaw members engage each other in a radial ramp configuration.

In some configurations, the apparatus further comprises a plurality of clamp fasteners extending through the housing assembly and into the housing channel, between the second end of the tube member and the distal end of the housing assembly. The clamp fasteners are adapted to engage a cladding of the electrical conductor.

In some configurations, the apparatus further comprises a dead end assembly extending from the proximal end of the housing assembly, the dead end assembly including a dead end flange.

In some configurations, the dead end flange includes a pad portion including four openings defining a square configuration with a centrally located fifth opening.

In some configurations, the apparatus further comprises a heel plug member having a tube portion threadedly coupled to the first end of the tube member and a dead end portion. The dead end assembly further includes a dead end flange having an opening through which the heel plug member is received. The hook member has a bore threadedly attachable to the dead end portion, to, in turn, sandwich the dead end flange between the hook member and the housing assembly.

In another aspect of the disclosure, the disclosure is directed to an electrical coupling apparatus defining a splice between a first electrical conductor and a second electrical conductor comprising a housing assembly. The housing assembly has a first side and a second side. Each of the first side and the second side extending in opposing directions from a central region, and each having a proximal end and a distal end, and defining a housing channel. Each of the first side and the second side including an actuating assembly, a core clamping assembly and a jaw clamp assembly. The actuating assembly includes a tube member and a toggle assembly. The tube member with a first end and a second end. The toggle assembly positioned within the tube member. The toggle assembly having a first toggle arm and a second toggle arm. The toggle assembly movable from a first orientation wherein the first toggle arm and the second toggle arm are oblique to each other to a second orientation wherein the first toggle arm and the second toggle arm are closer to being colinear than in the first orientation. The core clamping assembly including a core slot adapted to receive a core of an electrical conductor and a plurality of fingers extending in a direction opposite the toggle assembly. The core clamping assembly movable by the toggle assembly between the first and second orientation thereof. The jaw clamp assembly including at least one set of jaws including a plurality of base members and a plurality of corresponding inner jaw members, positioned within the tube member. The plurality of fingers is adapted to axially inwardly direct the inner jaw members through movement of the toggle assembly toward the second orientation, to, in turn, allow the inner jaw members to engage and retain the core of a respective one of the first and second electrical conductors thereby.

In some configurations, the apparatus further includes a heel plug member. The heel plug member positioned so that a first tube portion threadedly engages the first end of the tube member of the first side, and so that a second tube portion opposite the first tube portion threadedly engages the first end of the tube member of the second side.

In another aspect of the disclosure, the disclosure is directed to an assembly for retaining a core of a conductor comprising a core actuating assembly, a core clamping assembly and a jaw clamp assembly. The core actuating assembly includes a tube member and a toggle assembly. The tube member has a first end and a second end. The toggle assembly is positioned within the tube member. The toggle assembly has a first toggle arm and a second toggle arm. The toggle assembly movable from a first orientation wherein the first toggle arm and the second toggle arm are oblique to each other to a second orientation wherein the first toggle arm and the second toggle arm are closer to being colinear than in the first orientation. The core clamping assembly includes a core slot adapted to receive a core of an electrical conductor and a plurality of fingers extending in a direction opposite the toggle assembly. The core clamping assembly is movable by the toggle assembly between the first and second orientation thereof. The jaw clamp assembly including at least one set of jaws including a plurality of base members and a plurality of corresponding inner jaw members, positioned within the tube member. The plurality of fingers is adapted to axially inwardly direct the inner jaw members through movement of the toggle assembly toward the second orientation, to, in turn, allow the inner jaw members to engage and retain the core of the electrical conductor thereby.

In another aspect of the disclosure, the disclosure is directed to a method of retaining an electrical conductor comprising the steps of: providing an electrical coupling apparatus; inserting the core of the electrical conductor into the housing channel and the tube member; directing an end of the core of the electrical conductor into the core slot of the core clamping assembly; directing the toggle arms from the first orientation toward the second orientation; and moving the inner jaw members relative to the respective base members of the at least one set of jaws to engage the core of the electrical conductor.

In some configurations, the method further includes the steps of: directing a portion of a cladding of the electrical conductor into the housing channel; providing a plurality of clamp fasteners between the second end of the tube and the distal end of the housing assembly; and clamping a portion of the electrical conductor having the cladding therearound with the clamp fasteners.

### BRIEF DESCRIPTION OF THE DRAWINGS

The disclosure will now be described with reference to the drawings wherein:

FIG. 1 of the drawings is a perspective view of a configuration of the electrical coupling apparatus of the present disclosure, often referred to as a dead end and/or a dead end coupling;

FIG. 2 of the drawings is a side elevational view of the electrical coupling apparatus of the present disclosure;

FIG. 3 of the drawings is a cross-sectional view of the electrical coupling apparatus of the present disclosure;

FIG. 4 of the drawings is a top plan view of the electrical coupling apparatus of the present disclosure;

FIG. 5 of the drawings is a partial cross-sectional view of the electrical coupling apparatus of the present disclosure, showing, in particular, the actuating assembly, the core clamping assembly and the jaw clamp assembly;

FIG. 6 of the drawings is a cross-sectional view of the electrical coupling apparatus of the present disclosure, taken generally about lines 6-6 of FIG. 2;

FIG. 7 of the drawings is a cross-sectional view of the electrical coupling apparatus of the present disclosure, taken generally about lines 7-7 of FIG. 2;

FIG. 8 of the drawings is a cross-sectional view of the electrical coupling apparatus of the present disclosure, taken generally about lines 68-8 of FIG. 2;

FIG. 9 of the drawings is a perspective view of a portion of the electrical coupling apparatus of the present disclosure, showing, in particular, the actuating assembly, the core clamping assembly and the jaw clamp assembly along with the heel plug member;

FIG. 10 of the drawings is a perspective cross-sectional view of the portion of the electrical coupling apparatus of the present disclosure shown in FIG. 9;

FIG. 11 of the drawings is a perspective cross-sectional view of a portion of the electrical coupling apparatus of the present disclosure, showing the initial positioning assembly, the toggle assembly along with the heel plug member;

FIG. 12 of the drawings is an exploded perspective view of the core clamping assembly, showing, in particular, the end retaining housing, the pusher member and the grab ring thereof;

FIG. 13 of the drawings is an exploded perspective view of the socket and the bushing of the jaw clamp assembly of the electrical coupling apparatus of the present disclosure;

FIG. 14 of the drawings is a perspective view of a set comprising a base member and a corresponding inner jaw member of the jaw clamp assembly of the electrical coupling apparatus of the present disclosure;

FIG. 15 of the drawings is a side elevational view of a set comprising a base member and a corresponding inner jaw member of the jaw clamp assembly of the electrical coupling apparatus of the present disclosure;

FIG. 16 of the drawings is a perspective view of a spacer of the type utilized in association with the jaw clamp assembly of the electrical coupling apparatus of the present disclosure;

FIG. 17 of the drawings is a perspective view of another configuration of the electrical coupling apparatus of the present disclosure, showing, in particular, what is often referred to as a splice and/or a splice coupling; and

FIG. 18 of the drawings is a perspective cross-sectional view of the configuration of the electrical coupling apparatus of the present disclosure as shown in FIG. 17; and

FIG. 19 of the drawings is a partial perspective cross-sectional view of the configuration of the electrical coupling apparatus of the present disclosure as shown in FIG. 17, showing, in particular, the heel plug member thereof.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

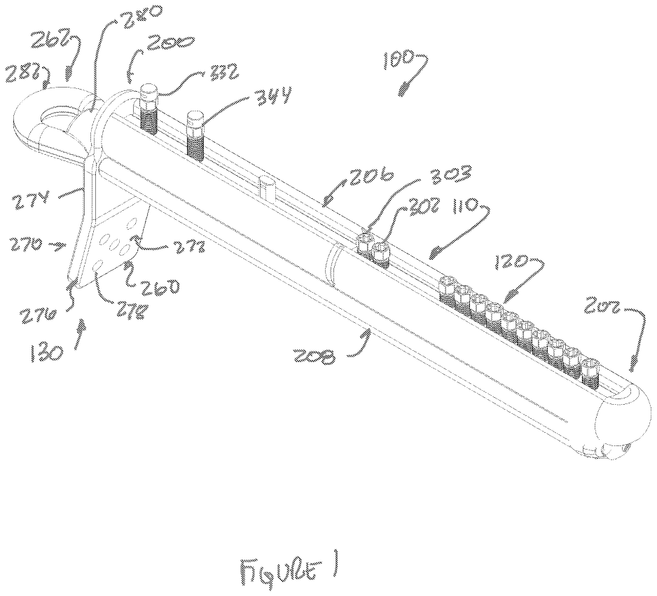

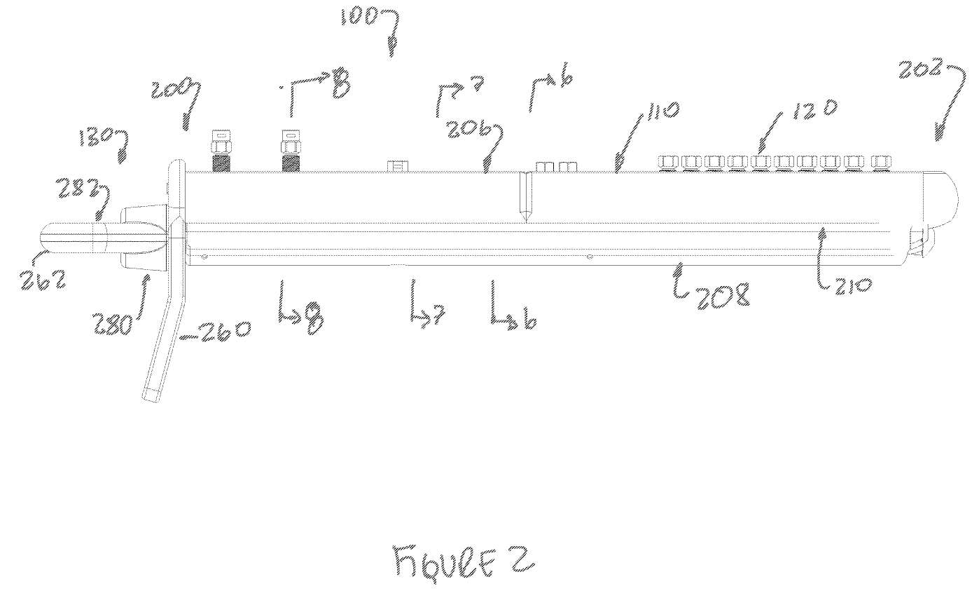

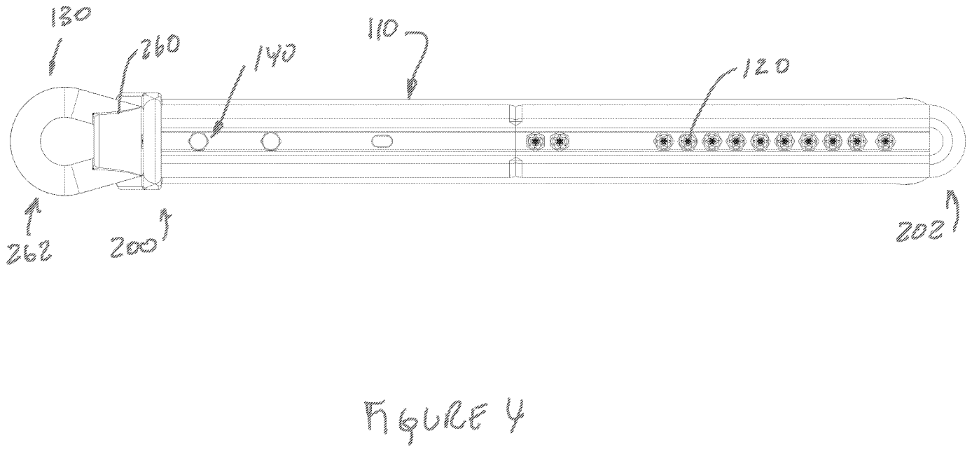

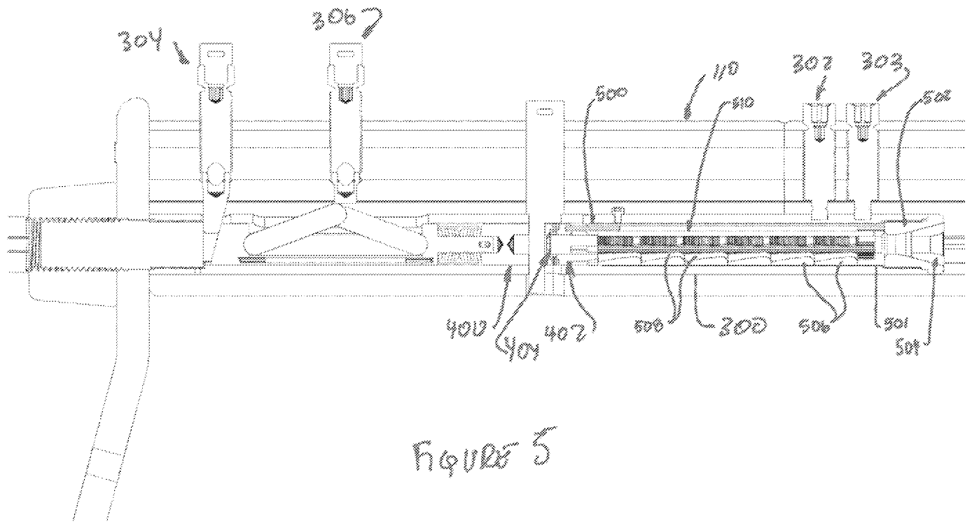

Referring now to the drawings and in particular to FIGS. 1 through 5, the electrical coupling apparatus is shown generally at 100. It will be understood that such an electrical coupling is typically intended for use in association with electrical transmission and distribution conductors, which typically have voltages that may be as high as 765,000V or higher, while the disclosure is not limited to any particular voltages. In the configuration shown, the electrical coupling apparatus is a dead end which is typically used to terminate such electrical conductors. The principles of the disclosure are not limited to use in association with dead ends, but can be used in other applications associated with the grasping and retaining of electrical conductors, such as the splice shown hereinbelow, as an additional example.

The electrical coupling apparatus 100 is shown in FIGS. 1 through 5 as comprising housing assembly 110 having a dead end assembly 130. The electrical coupling apparatus 100 includes an actuating assembly 140, a core clamping assembly 150 and a jaw clamp assembly 160. It will be understood that the apparatus 100 (i.e., the dead end) can be used in without limitation in place of other conventional dead end applications.

The housing assembly 110 comprises an elongated tubular member having an proximal end 200 and a distal end 202, between which is defined a housing channel 204. The configuration of the housing is similar to that which is disclosed in U.S. Pat. No. 9,577,354 issued to Wolf et al. as well as in U.S. Pat. No. 11,569,591 issued to Tamm et al., the entire disclosure of each of which is hereby incorporated by reference in their entirety. For example, the housing assembly 110 includes upper assembly, lower assembly 208 and attachment assembly. The upper assembly 206 (which may comprise a single or as shown, two end to end components) includes a plurality of openings and a longitudinal channel 222. The longitudinal channel defines an inner surface 239. While in the present configuration the upper assembly is shown as being a generally uniform cross-sectional configuration (which may be formed by extrusion or the like, with post extrusion machining or the like, other configurations are contemplated as well, as well as variations in the cross-sectional configuration along the length thereof).

Among other openings, a plurality of first openings 230 are disposed proximate the distal end 202, which openings are threaded in the configuration. As will be explained, these openings accept clamp fasteners that are configured to clamp the conductor (having both the core and the conductor by, typically, clamping against the outside of the conductor, while piercing fasteners are contemplated which may pierce the connector and/or engage the conductor). It will be understood that while a total of ten openings are presented for the receipt of up to ten clamp fasteners, other configurations may provide a different amount of fasteners. It is further contemplated that in some configurations, a different manner of capturing the core is contemplated in the place of the first openings and the configuration of the upper and lower assemblies, as the actuating assembly, the core clamping assembly and the jaw clamp assembly can be adapted for use with other housing assemblies.

A pair of second openings 232 are spaced apart therefrom toward the proximal end 200. The second openings are likewise threaded and structurally adapted to receive the tube locking fasteners 302, 303 which retain the tube member 300 in position relative to the housing assembly 110. It will be understood that in other configurations, a greater or lesser number of openings is contemplated. Additionally, other manners of securing the tube member relative to the housing assembly (other than utilizing fasteners that extend through the housing assembly are contemplated.

A toggle opening 234 is positioned between the second openings and the proximal end, which toggle opening is also threaded. As will be explained, the toggle opening is structurally adapted to receive the toggle fastener. A wedge opening 236 is positioned between the toggle opening and the proximal end of the housing assembly, and is threaded. As will be explained, the opening is structurally adapted to receive the disk wedge fastener 332. An additional opening is disposed between the second openings 232 and the toggle opening 234, so provide an inspection port to allow for visual identification of the proper position of the electrical conductor (generally the core or portions of the core thereof) being properly positioned within the housing assembly prior to and during clamping. In the configuration shown, a locking member may be inserted into this opening prior to use of the apparatus.

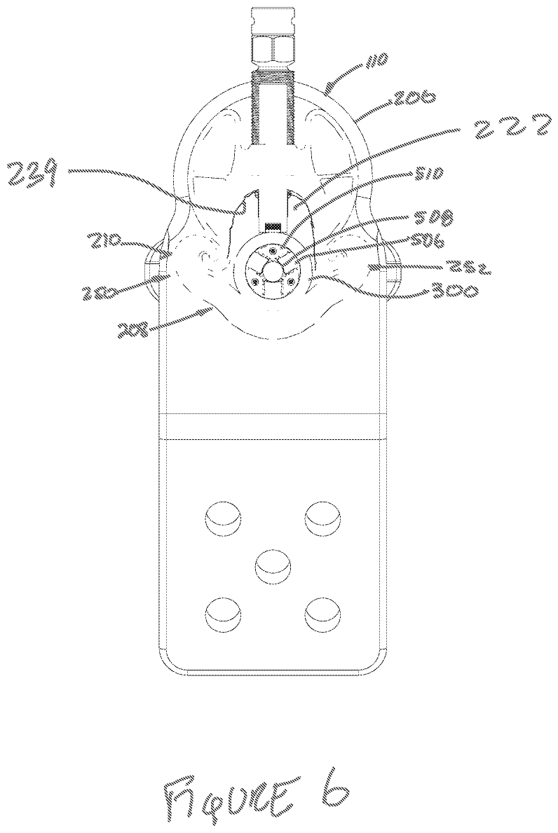

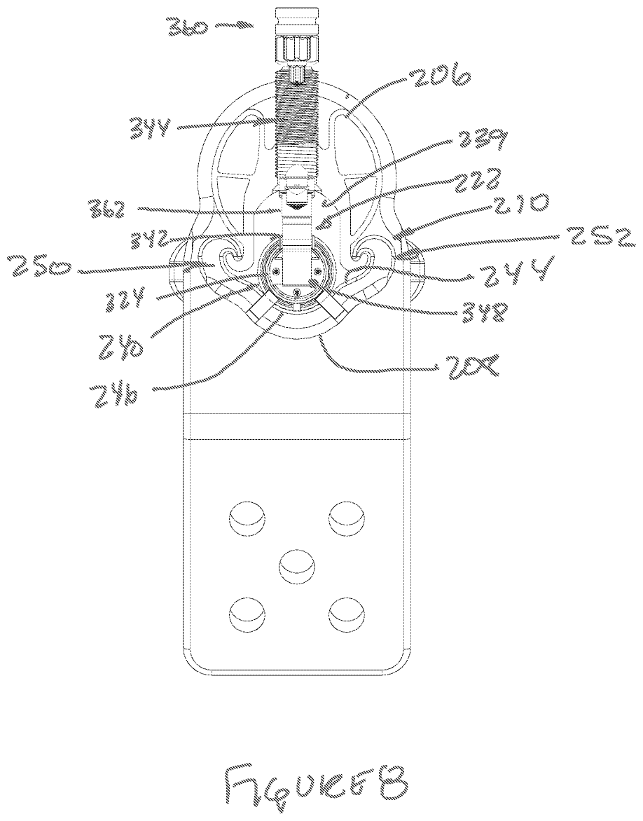

With further reference to FIGS. 6 through 8, the lower assembly is shown as comprising longitudinal channel 240 with inspection opening 242 aligned with the inspection opening 238 of the upper assembly 206. The longitudinal channel of the lower assembly 208 defines inner surface 244 and lower portion 246. As with the upper assembly, the lower assembly may be formed through an extrusion process, wherein the cross-sectional configuration is substantially uniform along the length thereof. It will also be understood that a cap or the like may be positioned over the distal end 202 of upper and lower assemblies collectively (in an effort to provide convex configurations at the distal end, which may improve performance). Such a cap may be attached through fastening or through welding or other joining systems.

The attachment assembly 210 is defined by structures on either side of each of the upper assembly 206 and the lower assembly 208, and includes a first side connector 250 and a second side connector 252 opposite the first side connector 250. In the configuration shown, the attachment assembly is such that the upper assembly and the lower assembly are slidably coupled along the length thereof. In other configurations, the attachment may comprise a snap connection, or a fastener based connection. Additionally, the components may be welded together.

The dead end assembly 130 is shown in FIGS. 1 through 4 as comprising dead end flange 260 and hook member 262, which are attached to each other and/or the housing assembly through heel plug member 212, as will be described below. The dead end flange 260 comprises an outer side facing away from the housing assembly and an inner side opposite the outer side. Coupling portion 274 of the dead end flange 260 abuttingly engages the proximal end 200 of the housing assembly 110, and includes an opening that is configured to receive the heel plug member 212 therethrough. In the configuration shown, the coupling portion of the dead end flange is generally perpendicular to a longitudinal axis of the housing assembly. Pad portion 276 of the dead end flange is generally oblique to the coupling portion and includes a plurality of openings. In some configurations, a total of four openings that are in a square configuration may be utilized. However, for other applications an additional opening (in the configuration show, a centrally located fifth opening) may be defined on the pad portion, for example, for situations wherein larger electrical conductors are utilized and/or where larger loads are experienced and/or where higher operating temperatures are contemplated, among other reasons, without limitation.

The hook member 262 extends from the outer side 270 of the dead end flange and includes base 280 and U-shaped portion 282. As will be explained, the base includes a bore 284 that, in the configuration shown is threaded, and which allows for the receipt of a dead end portion 256 of the heel plug member to be threadedly engaged (with the tube portion 254 extending through the opening 277 of the coupling portion 274 and threadedly engaging the tube member 300). In the configuration shown, the U-shaped portion defines a plane that is substantially parallel to the longitudinal axis of the housing assembly opposite the tube member 300. Of course other configurations (it will be understood that U-shaped can be considered to include a hoop-like element to which a hook, cable or the like may be extended), are contemplated, such as male hook members or the like in place of the female U-shaped portion.

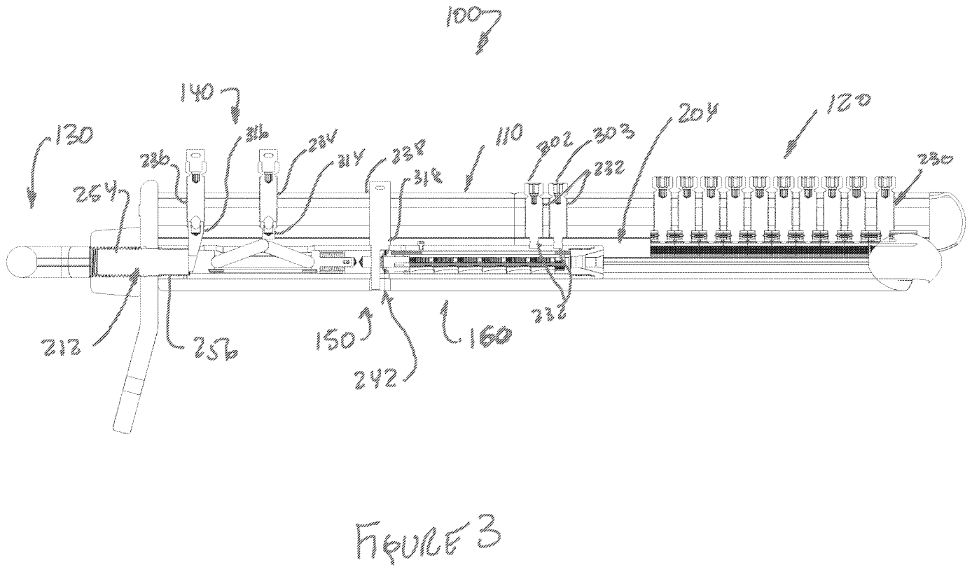

With reference to FIG. 3, the heel plug member 212 may be threaded at both ends, while a portion remains unthreaded so as to interface with the opening 277 of the coupling portion. In other configurations, keyed structures are contemplated, as are welded configurations, wherein the dead end flange and the dead end hook member may comprise a single element which may be a single integrally formed member which would include separate components that may be welded together.

As will be explained in detail below with respect to the method, for electrical conductors having a core (which may comprise, for example, a plurality of steel cables which may be helically wrapped or which may be configured together, or a composite structure) with an electrical carrying component, often referred to as a cladding (typically, one or more layers of aluminum cables which may be disposed, typically helically, about the core), the cladding may be removed from the end of the electrical conductor such that the core extends into the jaw clamp assembly 160 and the core clamping assembly 150 so as to be initially captured thereby, with the actuating assembly 140 providing the clamping of the core within the housing assembly. The clamp fasteners 120 may be utilized to clamp the cladding (and to some extent the core) within the housing assembly. Against that backdrop, which will further be expanded below, the actuating assembly 140, the core clamping assembly 150 and the jaw clamp assembly 160 will be described.

With further reference to FIGS. 1 through 5 and 9 through 10, The actuating assembly 140 includes tube member 300, initial positioning assembly 304 and toggle assembly 306. These structures are positioned within the housing channel 204 of the housing assembly, and generally along the longitudinal axis thereof. The tube member 200 is defined by a first end 310, a second end 312, and includes a wedge opening 314, a toggle slot 316, inspection openings 318 and locking slots 320. In the configuration, the tube member 300 is generally of a substantially uniform cross-sectional configuration, which, in the configuration shown, comprises a generally circular cross-sectional configuration.

In the configuration shown, the first end 310 of the tube member 300 is internally threaded and abuts the coupling portion 274 of the dead end flange 260 and is attached thereto through the tube portion 254 of the heel plug member 212. To further preclude relative movement and/or rotation of the tube member relative to the housing assembly, in the configuration shown, a pair of tube locking fasteners 302, 303 extend through second openings 232 and engage locking slots 320. As will be understood, the screw heads are configured to break once sufficient torque is achieved on the tube locking fasteners, in the configuration shown. It will be understood that the fasteners may be of the type that are disclosed in U.S. Pat. No. 11,098,744 issued to Tamm et al., the entire disclosure of which is hereby incorporated by reference in its entirety (the same type of fastener can be utilized with each of the clamp fasteners, the disk wedge fastener, and the toggle fastener as well. While two fasteners extending through two openings into two locking slots are shown, it will be understood that a greater or lesser number of such structures is contemplated. Of course, other manners of securing the tube member to the housing assembly (so as to be stationary thereto) are contemplated, including, but not limited to additional fasteners, keyed components, mating components, as well as welded configurations, among others. In some configurations, the tube member may be formed as the part of or in place of the housing assembly, and the tube member may include a cover thereover.

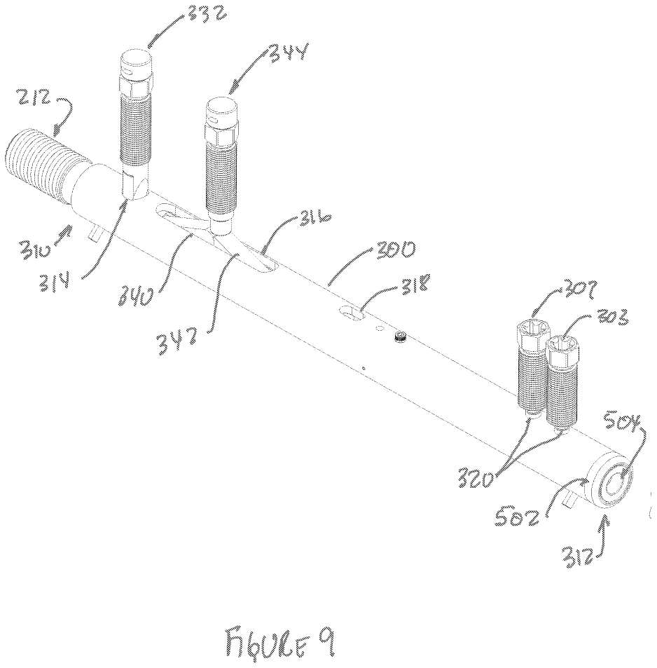

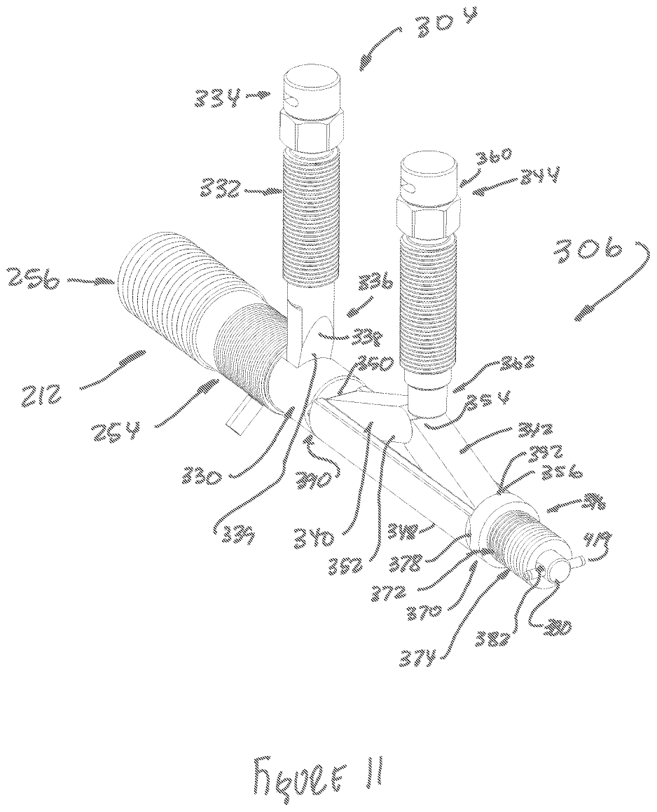

The initial positioning assembly is shown in FIGS. 9 through 11 as comprising disk taper 330 and disk wedge fastener 332. The disk taper comprises a slidable component positioned within the tube member proximate the first end 310 thereof. The disk taper includes a surface which is oblique to a longitudinal axis of the tube member 300. The surface is accessible through the wedge opening 314 and can be positioned opposite a surface defining the face of the tube portion 254 of the heel plug member 212. In the configuration shown, the surface defining the face of the heel plug member is generally perpendicular to the longitudinal axis of the tube member, with the disk taper being orthogonal thereto (and, in the configuration being substantially linear and tapering toward the wedge opening). Other configurations are contemplated for each, including inclined configurations, as well as other convex and/or concave configurations.

The disk wedge fastener 332 includes an upper end 334 that is threadedly extended through the wedge opening 236 of the upper assembly of the housing assembly 110, and a lower end 336 that defines a disk wedge 338 with a toggle surface 339 opposite a heel surface 337. As will be explained, as the disk wedge fastener is threaded into the tube member, the disk wedge 338 is driven between the heel plug member 212 on one side and the disk taper 330 at the other end, so as to drive the disk taper 330 along the tube member away from the heel plug member 212.

The toggle assembly 306 is shown as comprising first toggle arm 340, second toggle arm 342, toggle fastener 344, toggle plunger 346 and alignment channel 348. The first toggle arm 340 includes first end 350 and second end 352. First end 350 engages the disk taper on a side opposite the side engaging with the disk wedge. The first end 350 may comprise an outwardly convex surface that shape matingly engages with a mating surface on the disk wedge (in a, for example, male/female coupling), wherein the first toggle arm can pivot about the disk wedge, and the second end may comprise a similarly configured convex surface, in the configuration shown. The second toggle arm 342 comprises a first end 354 and a second end 356. The first end comprises an outwardly convex configuration that is configured to engage the second end 352 in pivotable engagement, with the second end 356 comprising an outwardly concave configuration that is configured to engage with the engagement surface 378 of the head 370 of the toggle plunger.

As will be described, in an initial position, the first toggle arm and the second toggle arm are generally oblique to each other, and oblique to the longitudinal axis of the tube member. In some configurations, such as the configuration shown, in such an orientation, the second end of the first toggle arm and the first end of the second toggle arm may extend out of the toggle slot 316, while remaining within the housing channel 204.

The toggle fastener 344 includes first end 360 and second end 362. The toggle fastener extends through the toggle opening 234 of the housing assembly 110, with the second end of the toggle fastener engaging the second end 352 of the first toggle arm 340 (and/or the first end 254 of the second toggle arm 342). It will be understood that as the toggle fastener is directed into the tube member, the second end thereof will act upon the toggle arms so as to drive them into alignment with each other (which applies force in opposite directions against the disk taper and the toggle plunger).

The toggle plunger 346 is shown as comprising head 370 and body 372 extending from the head 370, with the head generally matching the cross-sectional configuration of the tube member and with the body extending therefrom, generally along the longitudinal axis of the tube member toward the second end 312 of the tube member. In the configuration shown, the head 370 includes an engagement surface configured to engage the second end 356 of the second toggle arm 342 in pivoted engagement. Body 372 of the toggle plunger includes a distal end extending into toggle slot 416 of the end retaining housing 400. An alignment slot 382 is defined proximate the distal end, so as to be generally parallel to the longitudinal axis of the tube member and generally parallel to the travel of the toggle plunger within the tube member 300. As will be understood, the slot engages with an alignment pin 419 extending across toggle slot 416 of the end retaining housing 400 so as to facilitate alignment therebetween while permitting slidable movement therebetween.

A plurality of sets of Belleville spring washers, defining spring 374, encircle the body between the head 370 and the distal end 380 of the body 372. In the configuration, a set of opposing Belleville spring washers, each having six elements oppose each other. Of course, in other configuration, the Belleville spring washers may have different configurations, having fewer or greater numbers of elements in different sets. Additionally, it is contemplated that in place of or in addition to Belleville spring washers, other types of springs, such as helical springs, coil springs, a gas cartridge among others, are contemplated for use. Furthermore, a limiting busing 376 may encircle the body and the spring 374, so as to in part define the range movement of the toggle plunger 346 relative to the end retaining housing 400 in a compressive direction. As will be explained below, the use of the Belleville spring washers allows for further movement if, for example, seating of the jaws occurs during tensile loading of the electrical conductor. It may also be utilized to accommodate a range of core diameters.

Alignment channel 348 is positioned between the disk taper 330 and the toggle plunger 346 and includes first side 390 and second side 392. The alignment channel provides a guide for the first and second toggle arms 340, 342 as the arms enter the tube member and as the arms are directed toward the parallel orientation within the tube member 300. Pins on either side of the alignment channel 348 slidably engage, respectively, the disk taper and the toggle plunger so as to maintain alignment therewith.

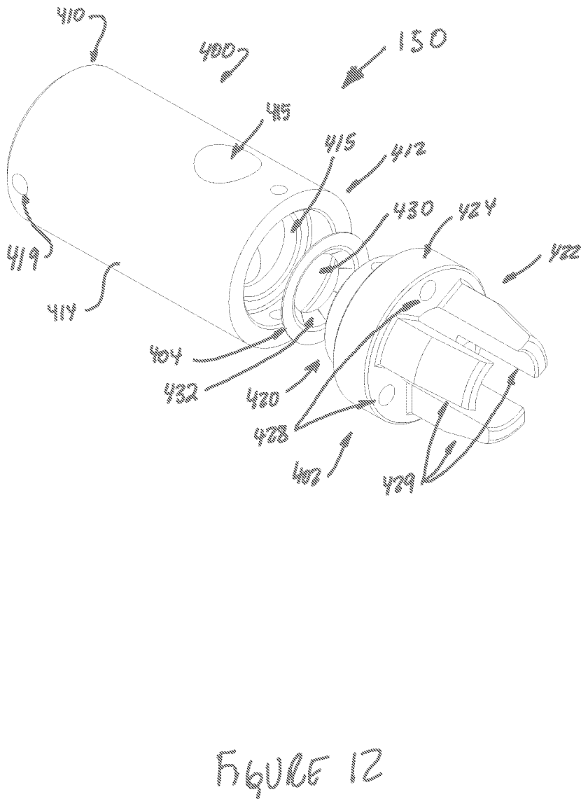

Core clamping assembly 150 is shown in FIGS. 9, 10 and 12 as comprising end retaining housing 400, pusher member 402 and grab ring 404. The core clamping assembly 150 is positioned within the tube member, engaging with the toggle plunger 346 of the toggle assembly 306. The end retaining housing 400 is defined by first end 410, second end 412 and outer surface 414, which corresponds to the tube member so as to facilitate slidably movement thereof within the tube member. As set forth above, toggle slot 416 is defined in the first end 410 and configured to receive the body 372 of the toggle plunger therewithin, with the alignment pin 419 extending across the toggle slot and through the alignment slot 382 of the body 372. A core slot 418 is defined in the second end 412 which is structurally configured to receive the end of the core of the electrical conductor that is to be clamped. An inspection opening 415 may extend transversely through the core slot so as to be positionable in an aligned orientation with the inspection opening 238 of the housing assembly and the inspection openings 318 of the tube member 300.

The pusher member 402 is shown as abuttingly engaging the second end 412 of the end retaining housing 400 (and in the configuration shown, joined thereto). The pusher member 402 is defined by first end 420 and second end 412, and outer surface 424. As with the end retaining housing, the pusher member 402 is slidably movable within the tube member 300. The pusher member 402 further includes core passage 426 extending therethrough and substantially corresponding to the core slot 418 of the end retaining housing 400. A plurality of alignment bores 428 and disposed about an outer rim of the pusher member which receive pins to facilitate alignment thereof with the spacers 520 of the jaw clamp assembly, and to substantially preclude relative rotation within the tube member 300.

A plurality of fingers 429 extend from the second end 422. The fingers are axially spaced apart from outer surface 424 so as to be spaced apart from the tube member 300. As will be explained, the fingers are positioned so as to engage the inner jaw members adjacent to the pusher member 402 and to move the inner jaw members 508 relative to the corresponding base members 506. As will be explained below, the orientation and the number of fingers is linked to the position and number of base members 506, inner jaw members 508 and/or spacers 510.

Grab ring 404 is positioned between the end retaining housing 400 and the pusher member 402 to be sandwiched therebetween. The grab ring includes bore 430 which corresponds to the core slot 418 and the core passage 426, with inwardly directed gripping barbs 432. As will be explained below, the directed gripping barbs engage the core of the electrical connector so as to allow the passage of the core therethrough in a first direction toward and into the toggle slot 416, while precluding removal of the core once passed therethrough. In other configurations, the grab ring may be part of end retaining housing, or the pusher member, or may be associated with one or the other, as opposed to being sandwiched therebetween.

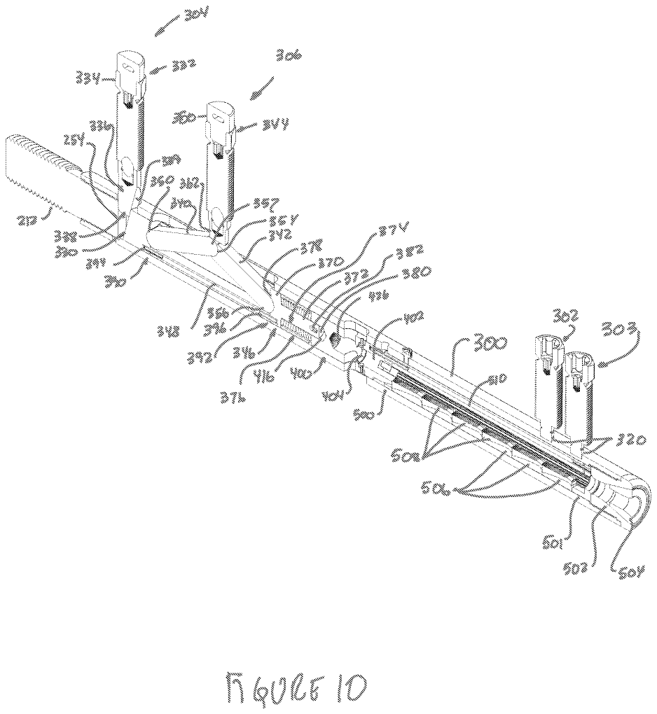

With reference to FIGS. 9 and 10, the jaw clamp assembly 160 is shown as comprising end plates 500, 501, socket 502, bushing 504, a plurality of base members, such as base member 506, a plurality of inner jaw members, such as jaw member 508, and at least one spacer, such as spacer 510. The end plates 500, 501 are spaced apart, so as to define a jaw region of the jaw clamp assembly 160. End plate 500 includes an opening that is configured to allow passage of the fingers 419 therebeyond (as well as the core of the electrical conductor). End plate 501 includes an opening to facilitate insertion of the core therethrough as well as fingers to preclude movement of the base members along the tube member 300.

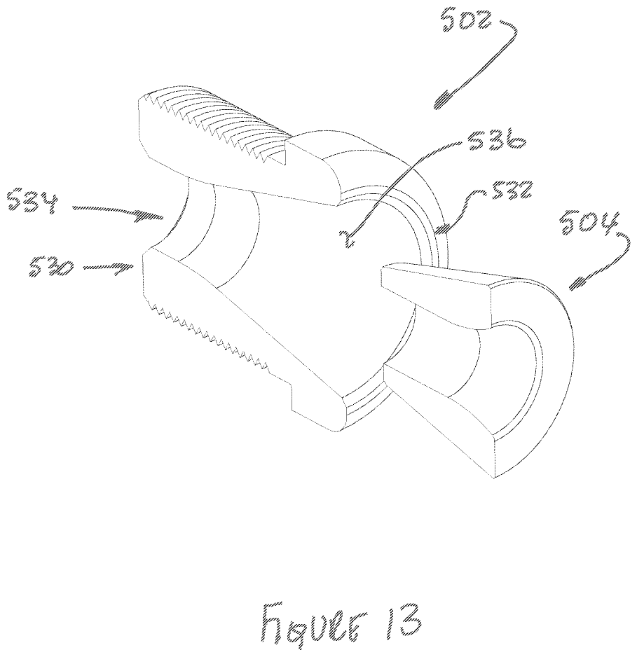

With further reference to FIG. 13, socket 502 is threadedly engaged with the second end 312 of the tube member so as to be substantially fixed thereto thereby substantially precluding slidable relative movement therebetween. The socket 502 includes inner end 530 that abuttingly engages the end plate 501, and outer end 532. Bore 534 extends therethrough and defines a bushing region 536. Bushing 504 is insertable into the bushing region 536 of the socket 502. It will be understood that the bushing is separable and can be directed around the core of the electrical conductor prior to insertion through the socket 502 so as to facilitate the insertion of the core of the electrical conductor into the tube member.

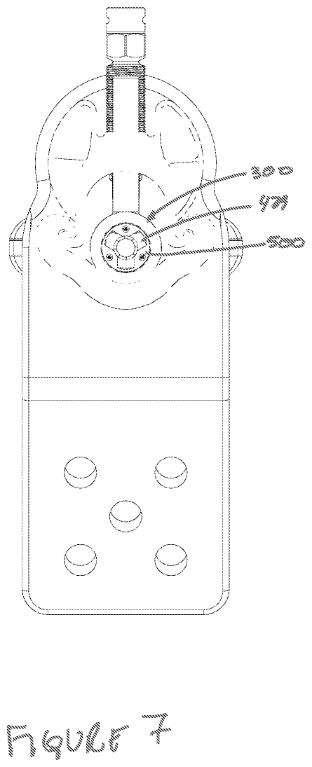

As can be seen in FIGS. 6 and 7, in the configuration shown, a total of three sets of inner jaw members and base members are presented, offset by 120° relative to each other about the tube member, and separated by three separate spacers 510 that extend along the tube member 300 between the end plate 500 and the end plage 501. One set of the inner jaw members and the base members will be described with the understanding that the remaining sets of base members and inner jaw members are substantially identical in operation (while they may have different configurations of the individual inner jaw member and base members). Similarly, opposing spacers 510 will be described with the understanding that further spacer members function in a similar manner. Furthermore, it will be understood that depending on the configuration, a greater or lesser number of sets of base members and inner jaw members are contemplated, as well as different numbers of spacers therebetween. For example, it is contemplated that a pair of sets of base members and inner jaw members may be spaced at 180° apart, four sets of base members and inner jaw members may be spaced at 90° apart, five sets of base members and inner jaw members which are spaced approximately 72° apart, or, for example six sets of base members and inner jaw members may be spaced 60° apart. Furthermore, while the spacing is shown and described as being uniform, it will be understood that other configurations, some of which may be symmetrical and some of which may be asymmetrical are contemplated and or asymmetrically spaced apart.

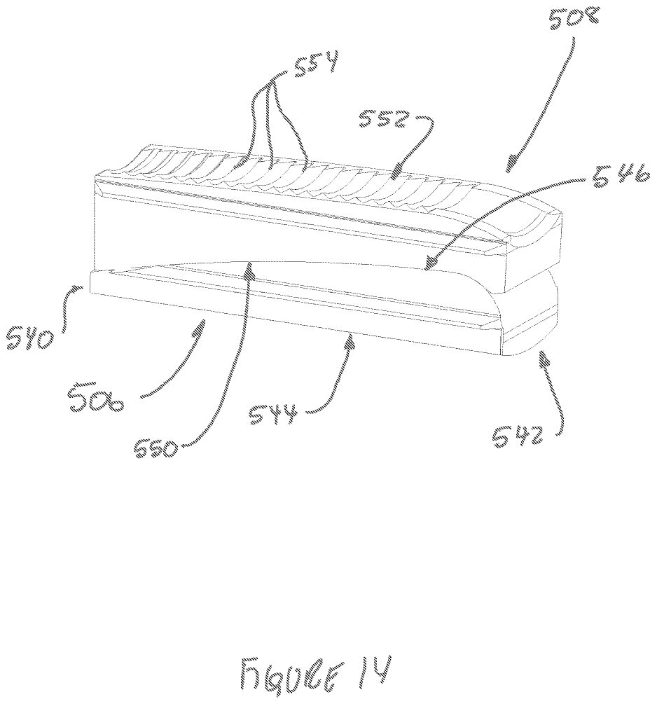

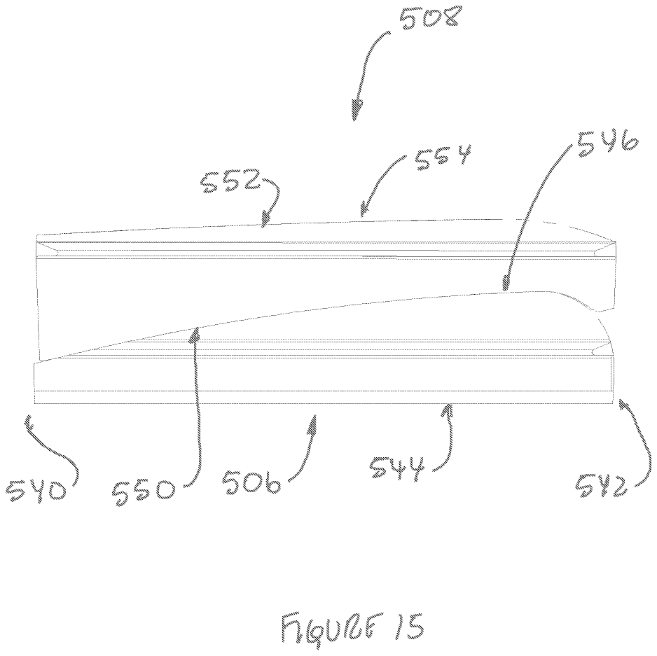

With further reference to FIGS. 14 and 15, base member 506 (of the set of base members), are defined by proximal end 540 and distal end 542, and include tube surface 544 and jaw surface 546 opposite the tube surface. It will be understood that a plurality of base members are positioned in an end to end fashion between the first end plate 500 and the second end plate 501. The tube surface 544 abuttingly engages the tube member 300, with the jaw surface 546 being at least partially engageable with a corresponding inner jaw member 508. In the configuration shown, the jaw surface 546 preferably comprises a radial ramp configuration as opposed to a linear configuration, as such a configuration provides a semi-cam action (as will be explained). In other configurations, a linear configuration of the jaw surface 546 may be utilized.

The inner jaw member 508 is disposed on the corresponding base member 506 and includes base surface 550 with core surface 552 opposite the base surface 550. In the configuration shown, the core surface 552 includes serrations 554 which are generally transverse to the direction of the core of the electrical conductor (and which may be inclined so as to dig into the core in the direction of removal of the core of the electrical conductor). As with the base member, the base surface 550 which interfaces with the jaw surface 546 of the base member 506 may be of a radial ramp configuration.

As will be explained, in a radial ramp configuration, the heel of the inner jaw member will be directed toward the core of the electrical conductor and reach the core prior to the remainder of the core surface due to the shorter distance created by the radial ramp configuration of the two surfaces. This further provides a graduated contact with the core of the electrical conductor. Additionally, the radial ramp configuration translates to a force multiplier. Of course, in other configurations, a linear (i.e., non radial ramp configuration) is contemplated for one or both of the base member and the inner jaw member.

As will be understood, each of the inner jaw members are likewise positioned end to end, with the understanding that the fingers 419 of the pusher member 402 when directed into the jaw clamp assembly 160 push the inner jaw members 508 toward the end plate 501 and away from the end plate 500 directing the inner jaw members axially inwardly. Continued movement of the fingers 419 continues the inward axial movement.

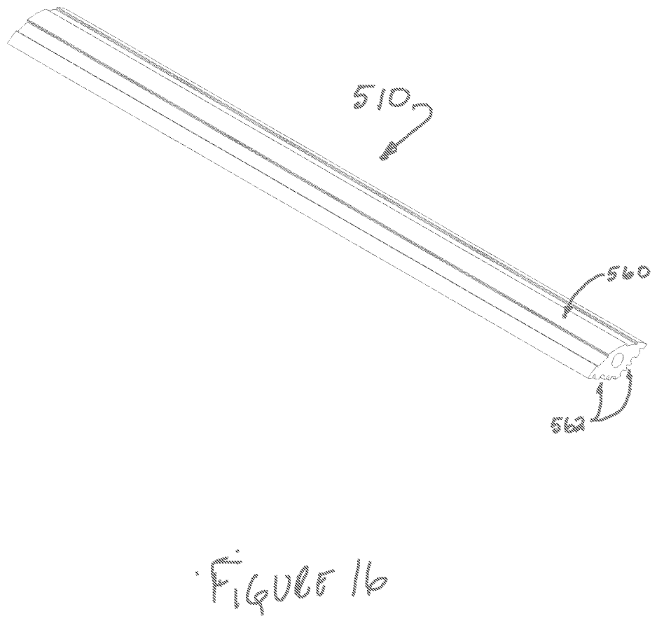

To maintain the inner jaw members 508 and the base members 506 in alignment and moving toward or away from the respective end plates, spacers, such as spacer 510 are positioned between sets of the members. With additional reference to FIG. 16, each of the spacers includes spacer tube surface 560 which abuts and engages the tube member, with spacer jaw surfaces 562 configured to engage an opposing side of the base and inner jaw members. In the configuration adjacent pairs of spacers define a channel along which the base members are confined (and generally precluded from movement), while the inner jaw members are configured to move linearly between the end plates (and generally precluded from side to side movement).

It will be understood that the individual inner jaw members can be varied in configuration, as can inner jaw members of various ones of sets of the inner jaw members. The same can be varied with respect to the base members. Furthermore, while the spacers are shown as being substantially similar, due to variations in the inner jaw members and base members, as well as variations in the configuration of the tube member, and/or the core of the electrical conductor, individual spacers may be varied relative to each other.

In operation, a user is first provided with the electrical coupling apparatus, which in this configuration comprises a dead end. The attachment of the dead end assembly will not be described as it will be understood to one of skill in the art how to attach the dead end assembly portion to a desired outside object, such as a transmission and/or distribution tower.

The electrical conductor is first prepared. In particular, a portion of the cladding is removed so as to expose the core, as the jaw clamp assembly and the core clamping assembly are configured to engage the core, with the clamp fasteners 120 being configured to engage the overall conductor having the core and the cladding. Once a suitable portion of the cladding has been removed, the electrical conductor is ready for attachment to the electrical coupling apparatus.

Additionally, in some configurations, the bushing 504 may be positioned onto the end of the core so as to simplify assembly. In other configurations, the core may be inserted without the bushing being placed onto the core first.

Additionally, as a part of the preparation, the tube member 300 is further secured to the housing assembly. This is achieved through the tightening of the tube locking fasteners 302, 303 through the second openings 232 and into the locking slots 320. Continued tightening further secures the tube member. It will be understood that at a predetermined torque, the fastener heads break precluding further tightening, utilizing the fasteners shown. In other configurations, it may be desirable to utilize a torque wrench or the like. This step may be accomplished prior to the introduction of the core into the housing channel 204 of the housing assembly 110 or may be accomplished after such insertion.

Next, with the bushing attached to the end of the core, the end of the core is inserted into the housing channel 204 of the housing assembly through the distal end 202. As the core continues, eventually, the core reaches the socket 502 and the cooperation between the bushing 504 and the bushing region 536 of the bore 534 centers the core relative to the tube member 300 to facilitate further insertion of the electrical conductor.

As the insertion continues, the bushing seats in the bushing region of the bore of the socket 502 allowing the core to slidably move into the tube member, and slidably along the bushing. The core passes the jaw clamp assembly exiting through the end plate 500 and then through the core passage 426 of the pusher member 402.

Eventually, the core encounters the grab ring 404, and as the core traverses the grab ring 404, the gripping barbs 432, while allowing for further insertion, oppose the retreat of the core back through the gripping barb. Continued insertion leads the core into the core slot 418 of the end retaining housing. As the core reaches the core slot 418, the core traverses the inspection opening 415 of the end retaining housing which is aligned with inspection openings 318 of the tube member and the inspection opening 238 of the housing assembly. Thus, the user can see that the core has been inserted into the core slot of the end retaining housing. In some configurations, the inspection port may be filled with a pin that is inserted through some or all of the insertion openings prior to use. In such a configuration, the pin is removed prior to passing the core therethrough

Additionally, as the core has reached the core slot of the end retaining housing, the cladding has entered into the housing channel 204, preferably to or beyond the first openings 230 of the housing assembly 110 (and thus, interfaceable with the clamp fasteners 120 extending through the housing assembly).

Once inserted to the extent possible, the user engages the disk wedge fastener 332 and tightens the same. As the disk wedge fastener is tightened, the disk wedge 338 is directed into the tube member driving the disk taper 330 away from the heel plug member 212. Similarly, such tightening will move the first and second toggle arms toward the distal end of the housing assembly, and move the toggle plunger toward the distal end. Outward movement of the toggle arms is precluded by the position of the toggle fastener 344, and alignment of the toggle fastener 344 with the second end 352 of the first toggle arm 340 is achieved through the tightening of the disk wedge fastener.

Additionally, such movement begins to compress the Belleville spring washers, moving the toggle plunger into the toggle slot 416 of the core clamping assembly 150. This may likewise move the core to fully bottom out within the core slot 418. Compression of the Belleville spring washers may continue until further compression is precluded by the limiting bushing 376 (which generally defines the minimum volume of the portion of the toggle plunger having the Belleville spring washers.

Eventually, once the right force has been reached within the tube member, further tightening of the disk wedge fastener results in the head of the disk wedge fastener shearing off, confirming that the right torque has been reached.

Once the disk wedge fastener is tightened as desired (i.e., to a particular torque of the fastener, to a particular displacement of the disk taper, or until the head of the disk wedge fastener is controllably breaks), and the toggle arms 340, 342 align as desired with the toggle fastener 344, the user can engage the toggle fastener and direct the toggle fastener to push at least one of the toggle arms 340, 342 from an initial oblique orientation toward a co-linear orientation wherein the first and second toggle arms are co-linear with each other. Such movement displaces the toggle plunger toward the second end of the tube member 300.

As the toggle fastener 344 is tightened, and the toggle plunger is forced toward the second end of the tube, the fingers 429 of the pusher member 402, press beyond the end plate 500 and engages the initial set of inner jaw members 508. As the inner jaw members 508, aligned end to end, are pushed by the respective one of the fingers 429, due to the engagement with the respective base members, the inner jaw members 508 are directed axially inwardly, as they are directed toward the second end plate 502. The inner jaws approach and contact the core of the electrical conductor, with the serrations 554 engaging and biting into the core while applying axially inward pressure thereagainst. With the configuration of the base members and the inner jaw member, in the configuration shown, the radial ramp configuration facilitates the engagement of the heel of each of the inner jaw members with the electrical core, generally first, prior to engagement of other regions of the inner jaw members.

As the first and second toggle arms reach a co-linear configuration, the force applied by the inner jaw members against the core of the electrical conductor is sufficient to retain the core within the tube member. Additionally, with the toggle fastener shown, as the proper torque is reached on the fastener, the head of the toggle fastener will break indicating that the desired position of the toggle arms has been reached. Of course, it will be understood that the various components can be sized so that the appropriate force and/or displacement is reached at the time that the heads controllably break from the fasteners. It will further be understood that a torque wrench or the like can be utilized with non-breakable fasteners to insure that the appropriate force and/or displacement is reached.

Next, the clamp fasteners are tightened so as to clamp the core and the cladding of the electrical conductor are clamped between the clamp fasteners and the housing assembly to preclude inadvertent and/or undesirable movement of the cladding relative to the core and relative to the housing assembly. It will be understood that such clamping by the clamp fasteners may have a clamping effect on the core that is encircled by the cladding.

It will be understood that the Belleville spring washers maintain an axial force when fully installed. The Belleville spring washers can apply an additional axial force if further seating of the jaws occurs during tensile loading. Further, the configuration allows for the accommodation of a range of core diameters, as the Belleville spring washers can accommodate more travel.

It will be understood that there may be a mix and match configuration, wherein certain features of the actuating assembly, the core clamping assembly and the jaw assembly may be omitted or the like. In addition to the features that may be varied, it will be understood that in certain configurations, the initial positioning assembly may be omitted. In other configurations, the toggle assembly may be varied so as to be fixedly engaged with the end retaining housing. In some configurations, the end retaining housing and the pusher assembly may be integrally formed, and the grab ring may be omitted or replaced with another type of one way structure that facilitates the insertion of the core within the bore, while precluding removal thereof.

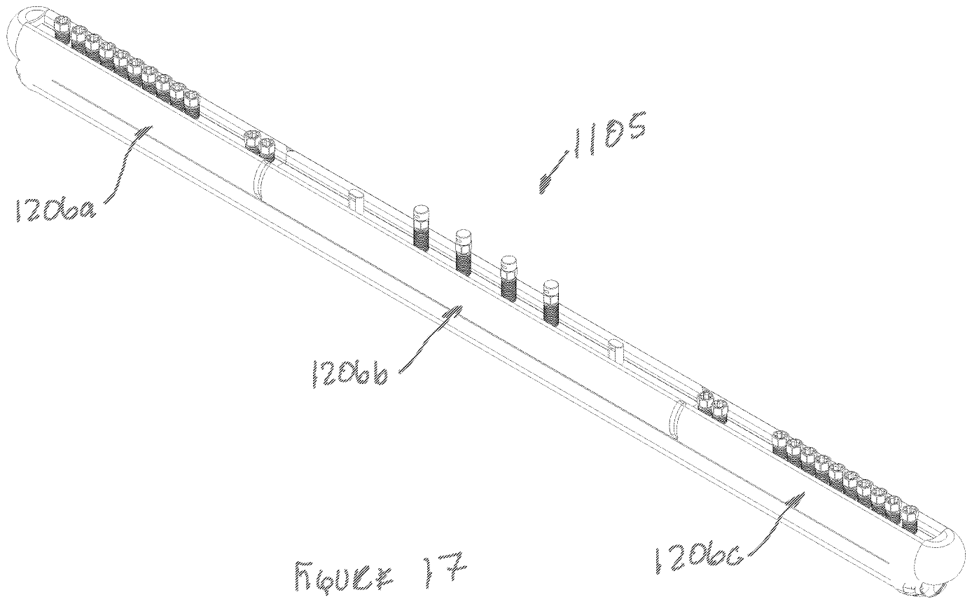

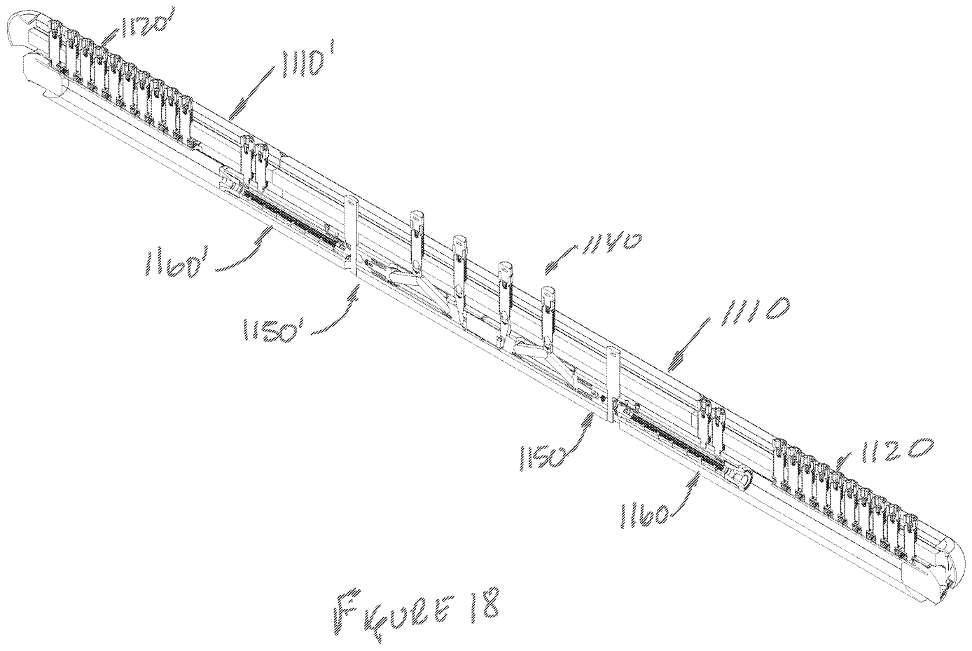

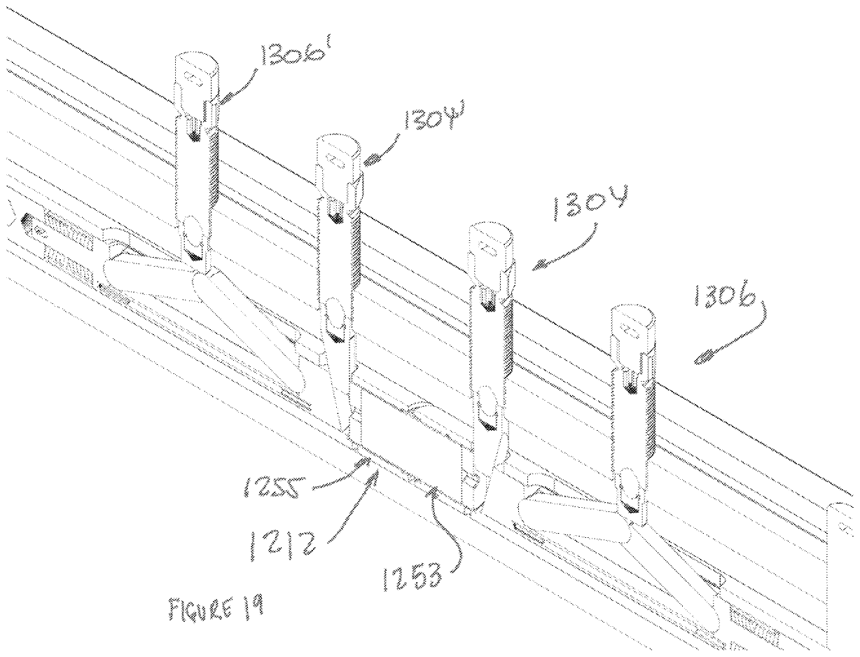

In another configuration, as is shown in FIGS. 17 through 19, the electrical coupling apparatus may comprise a splice member instead of a dead end assembly. It will be understood that a splice assembly comprises an electrical device which attaches mechanically (and preferably electrically) two electrical conductors, preferably in an end to end configuration. I will be understood that other configurations are likewise contemplated, including configurations that are not end to end configurations.

In the configuration of the splice assembly 1105 shown in FIGS. 17 through 19. It will be understood that similar components have been identified by similar reference numbers, augmented by 1000, with one side further including a prime (′). In the configuration shown, in place of a dead end assembly 130 (FIGS. 1 through 16).

In the configuration of a splice assembly, it will be understood that the housing assembly generally comprises two separate sides that are generally mirror images of each other. The housing assembly may comprise a single longer lower assembly 1208, while including three separate upper assemblies 1206a, 1206b and 1206c, with upper assembly 1206b being a central upper assembly with two opposing upper assemblies 1206a, 1206c which are mirror images of each other taken about a plane that is perpendicular thereto and generally located at the midpoint of the central upper assembly 1206b.

Additionally, in such a configuration, the heel plug member 1212 has a configuration that matingly engages tube member 1300 on one side and tube member 1300′ on the other side, through first tube portion 1253 and second tube portion 1253′, respectively. The heel plug member may be coupled to a bracket (which may be welded or the like) for positioning purposes. It will be understood that the heel plug member will be working in opposing directions in operation.

Generally otherwise, the configuration of the clamp fasteners 1200, 1200′ on either side, as well as the actuating assemblies 1140, 1140′, the core clamping assemblies 1150, 1150′ and the jaw clamp assemblies 1160, 1160′ are generally mirror images of each other, and on opposing sides of each other.

In the assembly of such a configuration, it is contemplated that each side may be assembled sequentially, or portions of each of side may be assemble back and forth, or that the two may be assembled simultaneously.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

1. An electrical coupling apparatus comprising:
a housing assembly having a proximal end and a distal end, and defining a housing channel;
an actuating assembly including:
a tube member with a first end and a second end;
a toggle assembly positioned within the tube member, the toggle assembly having a first toggle arm and a second toggle arm, the toggle assembly movable from a first orientation wherein the first toggle arm and the second toggle arm are oblique to each other to a second orientation wherein the first toggle arm and the second toggle arm are closer to being colinear than in the first orientation;
a core clamping assembly including a core slot adapted to receive a core of an electrical conductor and a plurality of fingers extending in a direction opposite the toggle assembly, the core clamping assembly movable by the toggle assembly between the first and second orientation thereof; and
a jaw clamp assembly including at least one set of jaws including a plurality of base members and a plurality of corresponding inner jaw members, positioned within the tube member, wherein the plurality of fingers is adapted to axially inwardly direct the inner jaw members through movement of the toggle assembly toward the second orientation, to, in turn, allow the inner jaw members to engage and retain the core of the electrical conductor thereby.

2. The electrical coupling apparatus of claim 1, wherein the toggle assembly further includes a toggle fastener having a first end and a second end, the toggle fastener threadedly coupled with the housing assembly so that the second end extends into the housing channel and engages the toggle assembly such that threading of the toggle fastener in one direction directs the toggle assembly toward a second orientation.

3. The electrical coupling apparatus of claim 1, wherein the toggle assembly further includes a toggle plunger engageable with the second toggle arm on a first side thereof, and engageable with the core clamping assembly at a second side thereof.

4. The electrical coupling apparatus of claim 3, wherein the toggle plunger is slidably movable relative to the core clamping assembly.

5. The electrical coupling apparatus of claim 4, further comprising a spring positioned between the toggle plunger and the core clamping assembly, the spring adapted to bias the toggle plunger away from the core clamping assembly.

6. The electrical coupling apparatus of claim 5, further comprising a limiting bushing between the toggle plunger and the core clamping assembly.

7. The electrical coupling apparatus of claim 5, wherein the spring comprises a plurality of Belleville spring washers.

8. The electrical coupling apparatus of claim 1, wherein the core clamping assembly further includes a grab ring having at least one gripping barb extending over a portion of the core slot, adapted to engage a portion of the core of the electrical conductor, to, in turn, limit removal thereof from the core slot.

9. The electrical conductor of claim 1, wherein the core clamping assembly includes an end retaining housing with the core slot being defined thereinto, and a pusher member includes a core passage aligned with the core slot, and wherein the fingers extending therefrom, with the grab ring being sandwiched therebetween.

10. The electrical conductor of claim 1, wherein the core clamping assembly further includes an inspection slot extending through the tube member and the housing assembly and being in communication with the core slot.

11. The electrical conductor of claim 1, further comprising an initial positioning assembly including a disk taper associated with the first toggle arm, and a disk wedge fastener threaded to the housing assembly and extending through the tube member, the disk wedge fastener having a second end with a toggle surface, the toggle surface engaging the disk taper with threading in a first direction directing the toggle surface to move the disk taper toward the jaw clamp assembly.

12. The electrical conductor of claim 10, wherein a heel plug member is threadedly fastened to the tube member at first end thereof with the second end of the disk wedge fastener being sandwiched between the heel plug member and the disk taper.

13. The electrical conductor of claim 1, wherein the jaw clamp assembly further includes at least two sets of base members and inner jaw members, spaced apart between the first and second ends of the tube member, with spacers positioned between the at least one pair of sets.

14. (canceled)

15. The electrical conductor of claim 1, wherein the jaw clamp assembly further includes a socket at the second end of the tube member and including a bore adapted to receive a core of the electrical conductor, and so that the sets of base member and inner jaw members are positioned between the core clamping assembly and the socket.

16. The electrical conductor of claim 1, wherein the jaw clamp assembly further includes a socket at the second end of the tube member and including a bore adapted to receive a core of the electrical conductor, and including a bushing region adapted to receive a bushing positionable about an end of the core of the electrical conductor.

17. The electrical conductor of claim 1, wherein the inner jaw members and the outer jaw members slidably move relative to each other.

18. The electrical conductor of claim 17, wherein the inner jaw members and the outer jaw members engage each other in a radial ramp configuration.

19. (canceled)

20. The electrical conductor of claim 1, further comprising a dead end assembly extending from the proximal end of the housing assembly, the dead end assembly including a dead end flange.

21. The electrical conductor of claim 20, wherein the dead end flange includes a pad portion including four openings defining a square configuration with a centrally located fifth opening.

22. (canceled)

23. An electrical coupling apparatus defining a splice between a first electrical conductor and a second electrical conductor comprising:
a housing assembly having a first side and a second side, each of the first side and the second side extending in opposing directions from a central region, and each having a proximal end and a distal end, and defining a housing channel;
each of the first side and the second side including:
an actuating assembly including:
a tube member with a first end and a second end;
a toggle assembly positioned within the tube member, the toggle assembly having a first toggle arm and a second toggle arm, the toggle assembly movable from a first orientation wherein the first toggle arm and the second toggle arm are oblique to each other to a second orientation wherein the first toggle arm and the second toggle arm are closer to being colinear than in the first orientation;
a core clamping assembly including a core slot adapted to receive a core of an electrical conductor and a plurality of fingers extending in a direction opposite the toggle assembly, the core clamping assembly movable by the toggle assembly between the first and second orientation thereof;
a jaw clamp assembly including at least one set of jaws including a plurality of base members and a plurality of corresponding inner jaw members, positioned within the tube member, wherein the plurality of fingers is adapted to axially inwardly direct the inner jaw members through movement of the toggle assembly toward the second orientation, to, in turn, allow the inner jaw members to engage and retain the core of a respective one of the first and second electrical conductors thereby.

24. (canceled)

25. (canceled)

26. A method of retaining an electrical conductor comprising the steps of:
providing an electrical coupling apparatus, the apparatus including:
a housing assembly having a proximal end and a distal end, and defining a housing channel;
an actuating assembly including:
a tube member with a first end and a second end;
a toggle assembly positioned within the tube member, the toggle assembly having a first toggle arm and a second toggle arm, the toggle assembly movable from a first orientation wherein the first toggle arm and the second toggle arm are oblique to each other to a second orientation wherein the first toggle arm and the second toggle arm are closer to being colinear than in the first orientation;
a core clamping assembly including a core slot adapted to receive a core of an electrical conductor and a plurality of fingers extending in a direction opposite the toggle assembly, the core clamping assembly movable by the toggle assembly between the first and second orientation thereof;
a jaw clamp assembly including at least one set of jaws including a plurality of base members and a plurality of corresponding inner jaw members, positioned within the tube member, wherein the plurality of fingers is adapted to axially inwardly direct the inner jaw members through movement of the toggle assembly toward the second orientation, to, in turn, allow the inner jaw members to engage and retain the core of the electrical conductor thereby;
inserting the core of the electrical conductor into the housing channel and the tube member;
directing an end of the core of the electrical conductor into the core slot of the core clamping assembly;
directing the toggle arms from the first orientation toward the second orientation; and
moving the inner jaw members relative to the respective base members of the at least one set of jaws to engage the core of the electrical conductor.

27. (canceled)
